(19) United States
(12) Patent Application Publication
(10) Pub. No.: US 2025/0128488 A1
(43) Pub. Date: Apr. 24, 2025

(54) APPARATUS FOR SUBDIVIDING A STRAND OF BRIQUETTES

(71) Applicant: MASCHINENFABRIK KÖPPERN GMBH & CO. KG, Hattingen (DE)

(72) Inventors: Eggert DE WELDIGE, Velbert Langenberg (DE); Ralf KLUSE, Hattingen (DE)

(21) Appl. No.: 18/728,166

(22) PCT Filed: Nov. 29, 2022
(86) PCT No.: PCT/EP2022/083630

§ 371 Date: Jul. 11, 2024

(30) Foreign Application Priority Data
Jan. 21, 2022 (DE) 10 2022 101 419.3

(51) Int. Cl. B30B 15/00; C21B 13/00

(52) U.S. Cl. CPC B30B 15/0005; C21B 13/004

(57) ABSTRACT

The invention relates to an apparatus (6) for dividing a briquette string (5) which has a plurality of contiguous briquette rows (5a) that are arranged one behind the other (in a longitudinal direction (L)) and each comprise, adjacent to one another, a plurality of briquettes (7) connected by material webs (8a, 8b), in particular for manufacturing briquettes (7) from direct reduced iron, said apparatus comprising: a movable beater device (9) which has a plurality of beaters (13) arranged adjacent to one another; and a feed device (10) via which the briquette string (5) can be fed to the beater device (9) in a transport direction (T), the beater device (9) striking the briquette string (5) fed by the feed device (10) with the beaters (13) in such a way that firstly a briquette row (5a) is knocked off the briquette string (5), and secondly the briquette row (5a) is divided into the individual briquettes (7). The apparatus is characterised in that: the beater device (9) and the feed device (10) are designed to divide a briquette string (5) having briquette rows (5a) which each have at least three briquettes (7) arranged adjacent to one another; and the beater device (9) has at least three beaters (13) arranged adjacent to one another.

The invention relates to an apparatus for subdividing a briquette strand holding, relative to a longitudinal transport direction, a succession of transverse rows of briquettes next to one another and connected together via material webs, in particular for the production of briquettes from directly reduced iron, the apparatus having
a movable beater assembly that has a plurality of beater teeth next to one another;
a feeder that supplies the briquette strand to the beater assembly in a transport direction such that the beater teeth of the beater assembly strike the briquette strand supplied by the feeder such that on the one hand a briquette row is struck off the briquette strand and on the other hand the struck-off briquette row/rows is/are subdivided into individual briquettes.

In addition, the invention relates to a plant for making briquettes, in particular a plant for hot briquetting (e.g. of directly reduced iron), with a briquetting press that continuously produces the briquette strand and an apparatus downstream of the briquetting press that subdivides the briquette strand emerging from the briquetting press. This apparatus for subdividing the briquette strand is also referred to as briquette separator or as briquette strand separator.

The apparatus or the plant preferably is for the production of briquettes from directly reduced iron or DRI (“directly reduced iron”), which is also called sponge iron or iron sponge. The briquettes are also termed hot-briquetted iron (HBI). The starting material is produced by direct reduction of iron ore that is used to produce the briquettes, and indeed preferably in one or in several briquetting presses for hot briquetting. Such briquetting presses are e.g. roller presses that e.g. have two counter-rotating press rollers, whose outer roller surfaces are provided with mold recesses or shaping recesses, so that as the material passes through the roller gap formed between the briquetting rollers a briquette strand is formed with a plurality of columns of briquettes next to each other and extending in the transport direction and consequently in the strand longitudinal direction and a plurality of transverse rows of the briquettes one after the other in the transport direction, and the briquettes in the columns and rows are connected together by material webs. To separate the briquette strand held together by via the material webs after the pressing process, the briquetting press is followed by the apparatus for separating the briquette strand as a “separating apparatus.” This separating apparatus, which is also referred to as a separator, is the basis of the invention.

The apparatus for subdividing the briquette strand has at least a beater assembly with the beater teeth on a for example rotationally driven beater drum that has an outer surface provided with a plurality of transverse rows of beater teeth next to one another. Furthermore the apparatus has a feeder supplying the briquette strand into the area of the beater assembly, such a feeder for example being a feed chute or feed slide or being constructed such that the briquette strand passes by gravity from the briquetting press into the area of the beater assembly. The feeder (e.g. the chute) has at its outlet end an impact edge running transversely to the transport direction of the briquettes, so that in the course of the movement of the beater teeth in the direction these teeth strike off the leading row of briquettes (i.e. a briquette bar). In addition, at least one lug is on or in the area of the feeder, e.g. at or below of the impact edge, so as to separate each struck-off row into individual briquettes.

The feeder can in addition be equipped with an additional hold down that presses the briquette strand fed from the briquetting press down onto the feed chute or feed slide and thus prevents deviation or doubling of the strand.

In practice in the briquetting presses (for hot briquetting) as a rule surface tools with two adjacent cavities are used so that a briquette strand with two briquettes next to each other briquettes is produced, i.e. the individual briquette rows each have two individual briquettes that are connected to each other via a material web. The separation of such a briquette strand takes place with a separator of the type described, where there is in practice below the impact edge a single lug for cutting apart the two briquettes of the briquette row.

Overall the components of such a system and of such an apparatus for subdividing the briquette strand are subject to high loads. In the case of hot briquetting, the components must withstand high temperatures since the hot briquetting takes place, for example, at temperatures between 250° C. and 750° C.

A system for making briquettes with an apparatus for subdividing a briquette strand of the type described above is known for example from of WO 1995/09080 [U.S. Pat. No. 5,666,638] and WO 1995/09079 [U.S. Pat. No. 5,630,202]. The beater assembly of the briquette strand splitter is a beater drum that interacts in the described manner with a feeder a chute or guide rail. The briquette strand fed from the press consists of two adjacent briquette columns so each individual, struck-off briquette row consists of two adjacent briquettes. In order to separate such a struck-off briquette row from the briquette strand, a single lug is provided at the feeder that cuts through the center web of the struck-off briquette row.

A comparable system is described in of DE 35 07 166, where the roller press has two counterrotating briquetting rollers that work together and that have outer surfaces formed with cavities that form the briquettes and produce a two-column briquette strand whose briquettes are connected to each other by webs and that are separated by a crusher such that both the webs running transversely to the strand longitudinal direction and also the longitudinal webs are crushed. The crusher has in turn a rotor with a plurality of retaining plates mounted on its outer surface and that move radially and have a recess in the center. During rotation of the crusher rotor, the retaining plates pass a crusher lug where the briquette strand sliding down the chute after leaving the front edge of the chute is still supported in the middle. As a result the briquette strand lies with the break edges running transversely to the strand longitudinal direction on the front edge of the chute and the retaining plates hit the individual briquettes. The briquette strand breaks at these breaking edges and in this way the individual briquettes are produced.

The same applies the plant of DE 25 14 703 where the briquette strand also has two columns next to each other, so that each individual briquette row consists of two briquettes that are separated via a single crusher lug.

Systems for briquetting and in particular for hot briquetting, in which a briquette strand is divided into individual briquettes with a separating apparatus, are also known in various embodiments from EP 3,183,371, U.S. Pat. Nos. 6,352,573, 5,731,272, 6,340,378 and EP 3,760,749 and WO 2008/078936.

EP 2,930,452 furthermore describes an apparatus for separating particles of a plate-shaped HBI strand, which has two rollers acting together.

Other embodiments of crushers or crushing apparatuses for briquetting are described in U.S. Pat. No. 3,300,815 and of DE 2,200,255.

The known plants for briquetting and in particular for hot briquetting rung are, as mentioned, as a rule equipped with briquetting presses in which a briquette strand is made with two briquette columns next to each other, i.e. formed by cavities on the outer surfaces of the rollers as two side by side circumferential rows of cavities on the roller surface. Making briquettes with such systems has proven itself in practice outstanding, since in particular perfect separation with the splitters described above succeeds, e.g. a beater drum interacts with an impact edge of the feed chute and a single lug.

In practice however there is the need to increase the production capacities and consequently the briquetting and in particular to optimize hot briquetting with respect to economic aspects. Here lies the invention.

The object of the invention is to provide an apparatus for subdividing a briquette strand and consequently a briquette separator of the type described above to economically make briquettes with simple construction and trouble-free operation.

This object is attained according to the invention with a generic apparatus of the type described above in which the beater assembly and the feeder subdividing a briquette strand operate with at least three longitudinal briquette columns such that at least three (e.g. at least four) adjacent briquettes are in longitudinally spaced transverse rows next to each other and the beater assembly has at least three beater teeth next to each other.

The feeder has at its outlet end preferably an impact edge for striking off the briquette rows and below the impact edge lugs for subdividing the struck-off briquette rows into individual briquettes, and the feeder has at least two transversely spaced lugs that are preferably in the area of the beating edge or below the beating edge.

The invention is based on the discovery that the economic efficiency of a plant for briquetting can be increased when the briquetting press creates a briquette strand that has not only two adjacent briquette columns, but more than two briquette columns, i.e. at least three briquette and preferably four briquette columns. The plant capacity is thus not simply increased by using more briquetting presses making the conventional briquette strands each with two briquette columns, but briquetting presses with higher capacity, namely with at least three briquette columns, preferably at least four briquette columns, are used. Going from this consideration, the briquette separator, i.e. the apparatus for subdividing the briquette strand, is set up such that a perfect subdivision of this briquette strand takes place, the briquette rows each having at least three briquettes next to each other. For this both the beater assembly and the feeder are optimized, because the beater assembly has at least three beater teeth next to each other and the feeder has e.g. at or below the impact edge two or also more lugs for cutting off the individual briquette rows, that are each formed according to the invention with at least three briquettes with two webs between the briquettes, e.g. at least four briquettes with three webs between the longitudinal rows of briquettes.

The striking-off is preferably (in a manner known in principle) executed by a rotationally driven beater drum or has such a rotationally driven beater drum. According to the invention, the beater drum has at least three annular arrays of beater teeth on its outer surface, so that each transverse row has at least three beater teeth next to one another. Alternatively a beater assembly can be used, that, instead of a rotationally driven beater drum, has a e.g. linearly movable beater element, that has e.g. an individual row of at least three beater teeth next to one another, And the linearly operating beater element is periodically moved in a straight line back and forth so as to be e.g. lowered and raised. Preferably however the above-described rotationally driven beater drum is used.

It is of particular importance in the context of the invention that the increased number of teeth on the beater assembly and the increased number of lugs and consequently protrusions below the striking edge of the feeder. To this end the invention proposes in a preferred further development, that the number n of beater teeth (in a row of beater teeth) on the beater assembly is one greater than the number m of lugs at the feeder, i.e. the number m of lugs at the feeder. I.e. n=m+1, with n∃3.

Alternatively or in addition, the number n of teeth at of the beater apparatus is equal to or smaller than the number b of briquettes in the briquette rows is, i.e. n=b or n<b, and with b∃3. is i.e. n=b or n<b, and although with b∃3, e.g. b∃4.

Alternatively or in addition, the number m of lugs of the feeder is smaller than the number b of briquettes in the briquette rows, i.e. m<b and indeed with b∃3 or e.g. with b∃4.

In a variant A of the invention the number n of teeth is equal to the number b of briquettes and the number m of lugs is smaller by one than the number b of briquettes and, for variant A, n=b and m=b−1 and consequently m=n−1. With this variant A, the number b of briquettes can be even or odd. In this variant A, each briquette in a row of briquettes is always assigned a beater, i.e. each briquette is hit by its own beater. Furthermore, each material web between two adjacent briquettes of a briquette row is assigned a lug, i.e. each material web of a briquette row (directly) hits a lug assigned to this material web during subdivision.

In a variant B of the invention the number n of beater teeth is smaller than the number of briquettes in the briquette rows and the number m of lugs is both smaller than the number b of briquettes in the briquette rows and smaller than the number n of beater teeth. This variant B is preferably only used for briquette strands whose briquette rows have an even number of briquettes, i.e. b is an even number. Preferably, n=b/2+1 and m=b/2. In this variant B, therefore, not every briquette in a briquette row is aligned with its own beater tooth, but preferably only the two outer briquettes of each briquette row are aligned with their own beater teeth. One or more pairs of briquettes are between the two outer briquettes and each of these pairs of briquettes is aligned with a common beater tooth. In this variant B, each material web of a briquette row is also not aligned with its own lug, but only the two outer material webs of a briquette row are each aligned with a lug and each further second inner web is aligned with a lug, i.e. for the inner material webs between the outer material webs, only each second web is aligned with a lug. Consequently, this variant B has both fewer beater teeth and fewer lugs than variant A described above. This design of variant B ensures in particular that a relatively large space is provided between the lugs, via which the inner briquettes can be discharged after separation, so that clogging is avoided particularly reliably.

It is always advantageous to ensure not only perfect separation of the briquettes but also a perfect and trouble-free discharge of the separate briquettes. For this purpose in the embodiments according to the invention it is particularly preferable that at least an inner beater tooth between outer beater teeth can pass between two (directly) adjacent lugs, so that in each case a beater tooth passes between to two adjacent lugs are traversed. Thus a perfect removal of the briquettes is ensured, and indeed in particular the inner briquettes that are in a briquette column between the outer briquette columns. One or several inner briquettes fall after the separation consequently not only (passively) through the area between the lugs, but they are pushed by at least a tooth through the space. This preferred embodiment can be realized both in connection with variant A and also with variant B.

A first embodiment of variant A is set up for example, for subdividing a briquette strand with three briquette columns, i.e. with briquette rows that each have three briquettes next to each other. In this case the beater assembly has three beater teeth and the feeder has two (offset) lugs, and each beater tooth is aligned with a briquette of a respective briquette column and each lug aligned with a material web between two adjacent briquettes. In this first embodiment of variant A, the individual beater teeth consequently directly strike the individual briquettes and the lugs act directly on the briquette webs therebetween, so that perfect separation takes place.

A second embodiment of this variant A of the invention is provided, for example, for subdividing a briquette strand with four briquette columns, i.e. with transverse briquette rows that each have four briquettes next to one another. The beater assembly has four beater teeth and the feeder has three (offset) lugs, each beater being tooth a briquette of a briquette column and each lug being aligned with a material web between two adjacent briquettes. Also in this second embodiment of variant A, the individual beater teeth, as in the first embodiment, consequently directly strike the individual briquettes and the lugs act directly on the webs therebetween, so that perfect separation takes place.

Variant A can be embodied in addition also with briquette strands with more than four briquette columns, where the individual briquette rows consequently have more than four briquettes next to each other, where the number of briquettes in a briquette row can be even or odd.

Unlike variant B, in which the number of beater teeth is less than the number of briquettes. One embodiment of this variant B can e.g. subdivide a briquette strand with four briquette columns, i.e. with briquette rows that each have four briquettes next to each other. The beater assembly has (only) three beater teeth and the feeder (only) two lugs. In this case therefore not each individual briquette of a briquette row has its own beater tooth and not each material web its own lug, but only the two outer beater teeth are aligned with the two outer briquettes, while the middle beater together strikes the inner pair of the briquette row. Here also only the two outer material webs are each assigned a lug. The central or middle material web is not assigned its own lug. Nevertheless a perfect division takes place also with this embodiment, and namely by the interaction and special configuration and number of beater teeth and lugs. For this reference is made to the figure description. It is particularly advantageous in this variant B that a lot of space is provided between the lugs so the (middle) briquettes can be discharged after their separation and blockages are especially reliably avoided.

This applies not only to this embodiment of variant B with four briquettes in a row of briquettes, but also to embodiments with six, eight or more briquettes in a row of briquettes, so that the number of briquettes is preferably even. Reference is also made to the description of the figures.

Of particular importance for flawless and economical operation of the system is in addition the fast and functionally reliable cutting and also the flawless discharge of the separated briquettes from the area of the beater assembly. In particular, malfunctions due to jamming or blockages in the area of the beater cleaning apparatus are to be avoided. For this purpose in a preferred embodiment of the several transversely adjacent lugs of the feeder the two outer lugs are formed in such a way and/or are oriented in such a way that the space between the respective outer lug and the adjacent inner lug next flares or widens in the working direction so as to discharge the divided or separated briquettes. This can be done e.g. in that the outer lugs are each obliquely oriented and/or have a thickness that tapers in the working direction. An oblique orientation and/or a tapering thickness in the working direction increases the transverse spacing between the lugs so as to create a widening space for the discharge of the individual briquettes in the working direction.

Further advantages are achieved by a preferred positioning of the lugs in the working direction. Thus optionally of the several adjacent lugs one or more or several of the other (e.g. neighboring and adjacent) lugs are relatively offset in the working direction. Thus there is the possibility that an inner e.g. central lug is offset downstream from the outer lugs next to it in the working direction. Thus the lugs are positioned in such a way that the beater teeth next to each other hit the briquette strand first via the two upstream outer lugs to separate the two outer briquettes and the downstream or back lug then separates the two middle briquettes. This also prevents malfunctions caused by jamming or clogging caused by the briquettes. In this embodiment, consequently the central or middle lug is offset by a predetermined dimension downstream from the two outer lugs. In an alternative embodiment, the central lug can also be upstream, so that on impact of the teeth flanking it the central web is split and only shortly then the two outer webs are split.

In one embodiment, a middle lug is dispensed with and only two (outer) lugs are provided, preferably at the same height.

The special arrangement of the lugs and in particular an oblique arrangement and/or an offset arrangement is in particular in embodiments of variant A of particular importance, so that each web is assigned a lug and the transverse spacing between all lugs is relatively small. Unlike this are embodiments of variant B where in any case there is a relatively large spacing between the lugs, since each web does not have its own lug. Even with this variant B, however, an angled arrangement of lugs or guide surfaces can be useful.

Alternatively or in addition to the inclined and/or offset arrangement of one or several lugs, the removal of the briquettes can be ensured by or improved in that during operation each pair of two adjacent lugs is longitudinally traversed by a respective beater tooth. The apparatus is therefore designed in such a way that at least an inner beater tooth between outer beater teeth passed between (directly) adjacent lugs during the operation.

The invention relates moreover not only to the described splitter or the described separator, but also a plant for making briquettes that is equipped with a such separator. The plant has at least a briquetting press, in particular a hot briquetting press, with which at least a briquette strand of the described type is continuously produced that has at least three, preferably four, briquettes next to each other in each of the transverse briquette rows. Furthermore, the plant has at least downstream of the briquette press and e.g. below the briquette presses a splitter of the type described that serves to cut the briquette strand emerging from the briquetting press. The splitter essential to the invention is consequently also a component of a briquetting plant and consequently in combination with an associated briquetting press in the scope of the invention.

Preferably the invention relates to the briquetting of hot material and consequently hot briquetting. Particularly preferably the invention relates to the hot briquetting of directly reduced iron and consequently to the production of HBI (hot briquetted iron). The invention can be used also for the briquetting or subdividing of a briquette strand of other material.

In the following the invention is explained in more detail with reference to a drawing that however shows embodiments. Therein:

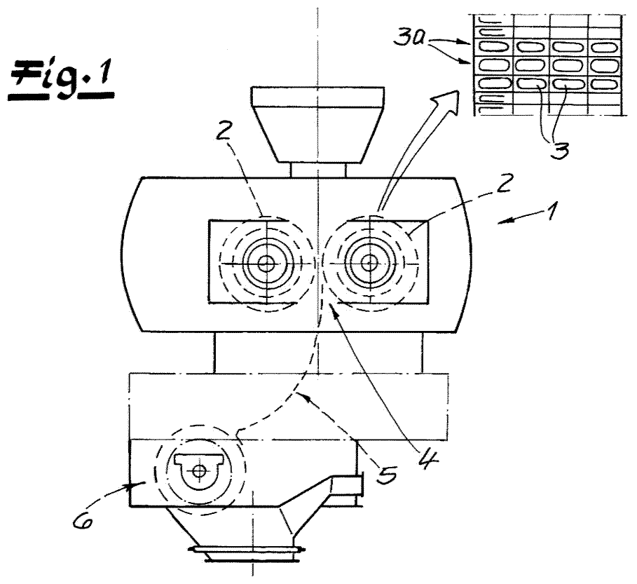

FIG. 1 is a simplified side view of a system for making briquettes;

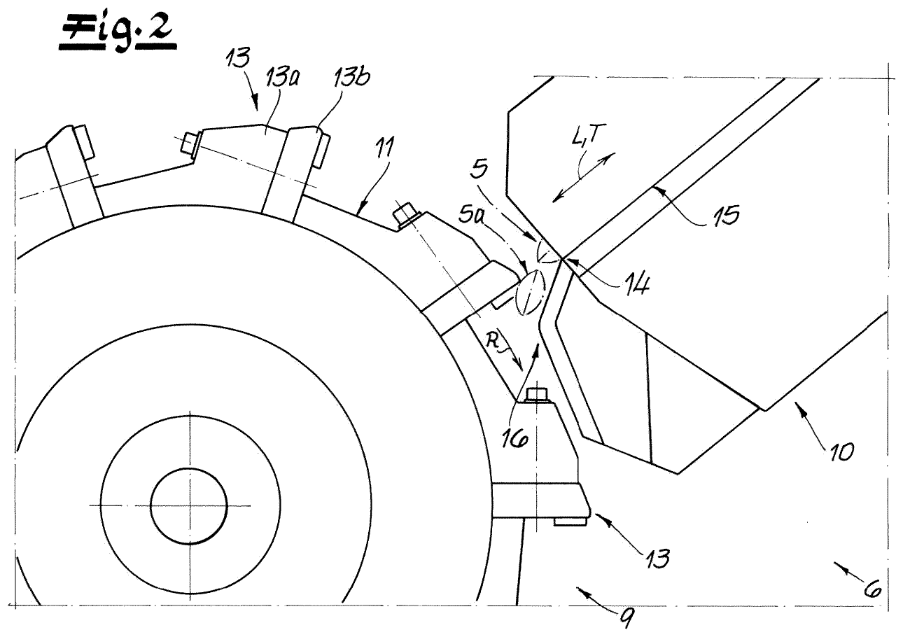

FIG. 2 shows an apparatus for separating the briquettes with the system of FIG. 1;

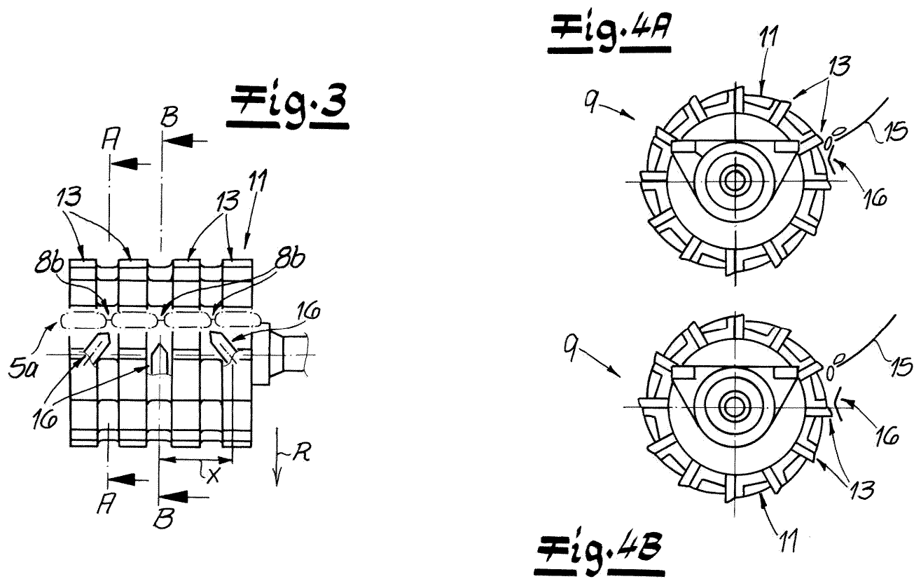

FIG. 3 is a side view of the outer surface of the beater of a first embodiment of the apparatus of FIG. 2;

FIG. 4A is cross section A-A through the beater of FIG. 3;

FIG. 4B is cross section B-B through the beater of FIG. 3;

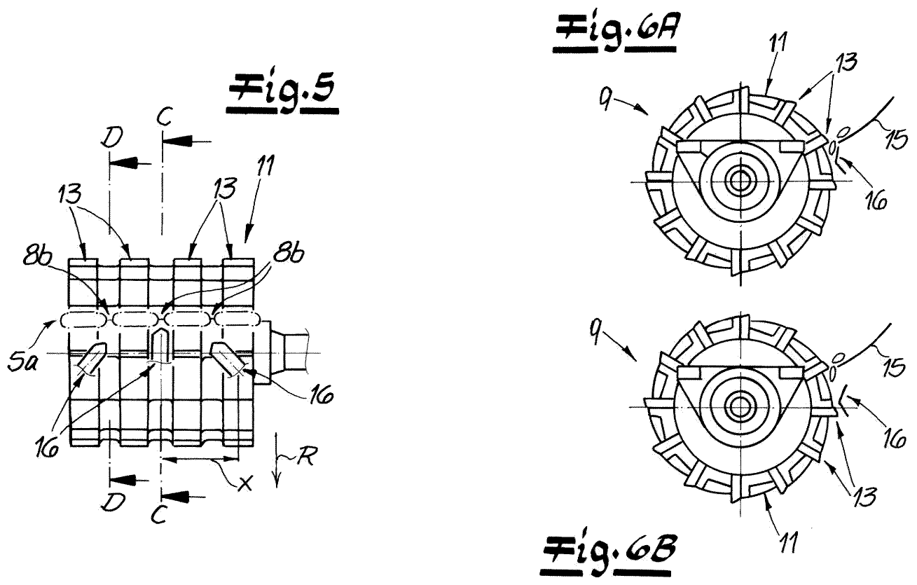

FIG. 5 shows a second embodiment of the invention;

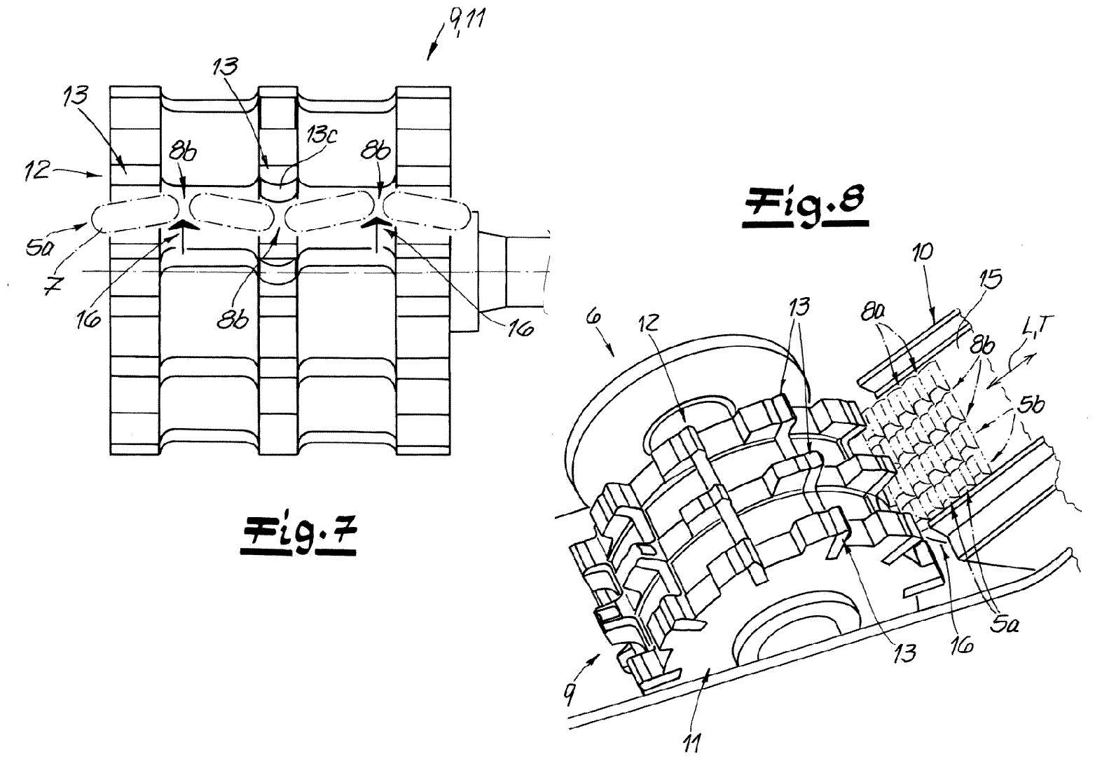

FIG. 6A is cross section C-C through the embodiment of FIG. 5;

FIG. 6B is cross section D-D through the embodiment of FIG. 5;

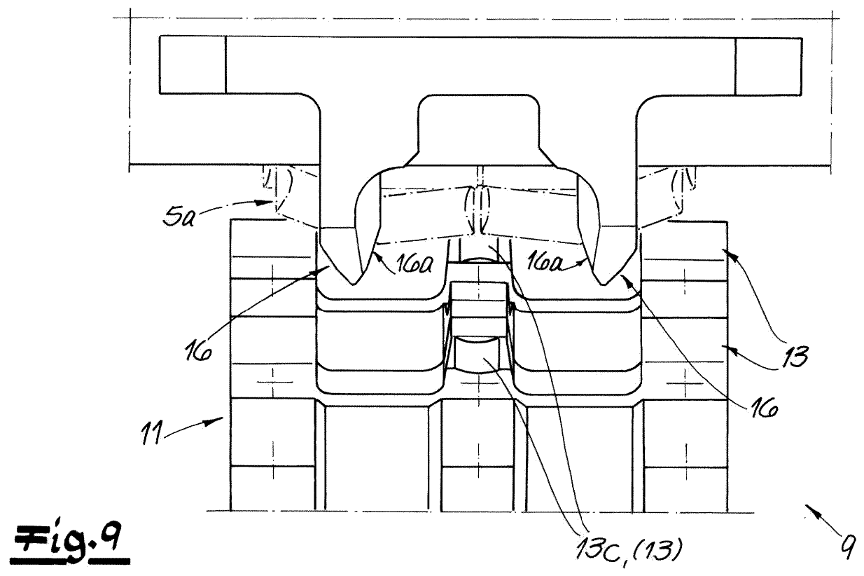

FIG. 7 shows a third embodiment of the invention;

FIG. 8 is a perspective view from above of the third embodiment of FIG. 7;

FIG. 9 is a bottom view of the third embodiment of FIG. 7;

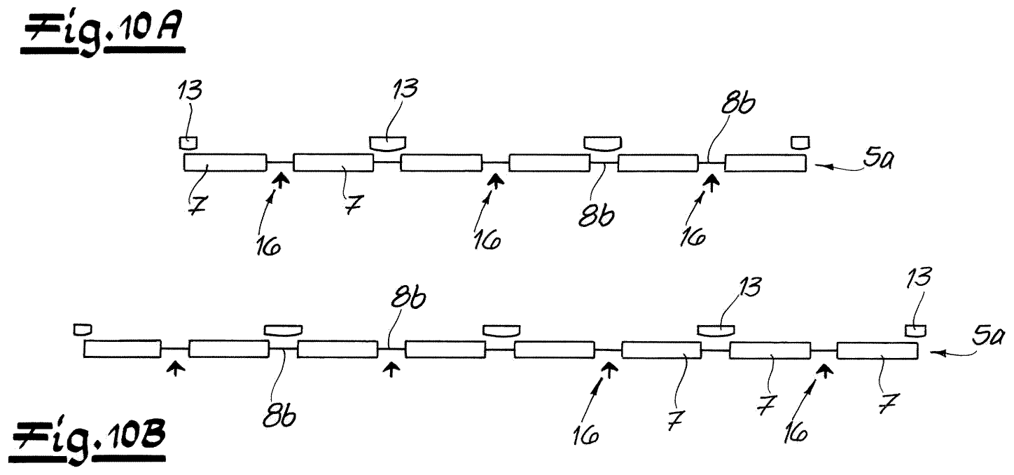

FIGS. 10A and 10B are further embodiments of the invention.

FIG. 1 shows a plant for briquetting and consequently is a plant for making briquettes that in particular is intended for hot briquetting. This plant has a briquetting press 1 that is equipped with two counter-rotating briquetting rollers 2, and the surfaces of the briquetting rollers 2 are provided with cavities 3 for forming briquettes. A briquette strand 5 emerges continuously from a roller gap 4 of the briquetting press and is then subdivided by a downstream splitter 6, i.e. the briquette strand is subdivided into individual briquettes 7. This splitter 6 is a component of the plant shown in FIG. 1 and is shown in the FIGS. 2 to 9 in detail.

The briquetting press 1 is designed within the framework of the invention for making a briquette strand 5 with briquette rows 5a one after the other in the longitudinal direction L and each having at least three, preferably at least four, briquettes 7 next to one another. For this purpose the rollers 2 of the briquette press 1 are formed on their outer surfaces with a plurality of rows 3a of cavities 3 and each row 3a in this embodiment has four mold cavities 3, so that the briquette strand 5 shown in FIG. 8 is produced that consists of four briquette columns 5b extending in the longitudinal direction L and a plurality of transverse briquette row 5a spaced in the longitudinal direction L one after the other each with four briquettes 7 next to one another, and the briquette rows one after the other are separated by transverse webs 8a, i.e. by webs extending transversely with the briquettes 7 of an individual briquette row 5a next to one another and consequently also the briquette columns 5b of the strand 5 are connected by longitudinal webs 8b.

The splitter 6 separating the briquette strand 5 consists in this embodiment of on the one hand a movable beater assembly 9 and on the other hand a feeder 10 that advances the briquette strand 5 in a transport direction T into the area of the beater assembly 9 (cf. e.g. FIG. 2). The assembly 9 is in this embodiment equipped with a rotatably driven beater drum 11 that has an outer surface provided with a plurality of rows 12 each carrying a plurality of beater teeth 13. This rotating beater drum 11 strikes with the beater teeth 13 in such a way onto the briquette strand 5 supplied to it that on the one hand a briquette row 5a is knocked off the briquette strand 5 and on the other hand the briquette row 5a is subdivided into the individual briquettes 7. According to the invention the beater assembly 9 on the one hand and/or the feeder 10 on the other hand supplies a briquette strand 5 with four longitudinal rows 5b of briquettes next to each other and also with transverse rows of briquettes 5a one after the other, which each have at least four briquettes 7 next to one another. In this illustrated embodiment, both the beater assembly 9 (i.e. the beater drum 11) and also the feeder 10 are adapted to the shape of the briquette strand 5 with the four briquettes next to each other 7. For this purpose, the beater assembly 9 or the beater drum 11 has at least three beater teeth 13 next to each other. In the illustrated embodiments, either three or four adjacent beater teeth 13 are provided. This will be discussed in detail further. The feeder 10 has in a fundamentally known manner an impact edge 14 at its output end for knocking off the briquette rows 5a. The feeder is or has a material chute 15. Furthermore, the feeder 10 can have an unillustrated hold-down apparatus, that presses the briquette strand 5 down onto the chute 15 in order to prevent deviation or doubling up. The end of the material chute 15 forms the impact edge 14 at which the briquette rows 5a are knocked off by the rotating beater drum 11, so that as it were briquette groups are separated as the briquette rows 5a. According to the invention, in the area of the subdividing edge 14 or below this edge 14 a plurality of lugs 16 or projections are provided such that in the course of hitting with the beater teeth 13 on the separated briquette row 5a this briquette row 5a is broken in turn into individual briquettes 7. Due to the effect of the beater teeth 13 on the end of the briquette strand 5, consequently at the impact edge 14, the transverse webs 8a between the briquette rows 5a are cut and are also cut at the lugs 16 the longitudinal webs 8b between the individual briquettes 7 of a briquette row 5a.

In the embodiments shown, the number n of beater teeth 13 at the beater assembly 9 is greater by one than the number m of lugs 16 on the corresponding feeder 10, i.e. n=m+1, in the illustrated embodiments n=3 or n=4.

In a variant A of the invention (according to FIGS. 3 to 6B), the number n of beater teeth 13 of the beater assembly 9 is equal to the number b of briquettes 7 in the individual briquette rows 5a so n=b. The number m of the lugs 16 on the feeder 10 is one smaller than the number b of the briquettes 7 in the briquette rows 5a, i.e. m=b−1. In this embodiment, b=4 (or alternatively also b∃3 or b∃4). For variant A, b can be even or odd. In this variant A, a separate tooth 13 is always aligned with each briquette in a briquette row and a separate lug 16 is aligned with each material web 8b between two adjacent briquettes in a briquette row.

This must be distinguished from a variant B (according to FIGS. 7 to 10B), in which both the number of beater teeth 13 and the number of lugs 16 is smaller than the number b of briquettes in a row of briquettes. For this variant B, n=b/2+1 and m=b/2. This means that only the two outer briquettes of a briquette row are each assigned their own beater and that at least one pair of briquettes is between the briquettes of a briquette row, with each pair of briquettes being assigned a common beater. This will be discussed below with reference to the examples.

Based on these general dimensional considerations FIGS. 3, 4A, 4B on the one hand and FIGS. 5, 6A and 6B on the other hand show two embodiments of variant A in which the beater assembly 9 comprises a plurality of rows 12 with four beater teeth 13, while the feeder 10 has three lugs 16 next to each other. In these embodiments each tooth 13 of a row 12 of beater teeth 13 is associated with a briquette 7 of a row 5a of briquettes. Each individual lug 16 is aligned with a material web, i.e. a longitudinal web 8b within a briquette row 5a and i.e. a longitudinal web 8b between two adjacent briquettes 7 within of a briquette row 5a. These figures show that the rotating beater drum 11 engages a row 12 of beater teeth 13 with four beater teeth 13 next to each other on a row of briquettes 5a with four briquettes 7, and indeed against the three lugs 16 below the striking edge 14, so that the row of briquettes 5a is separated. The same applies to the embodiment according to FIG. 5, 6A and 6B.

The embodiments according to FIG. 3 (or 4A, 4B) on the one hand and FIG. 5 (or FIG. 6A and 6B on the other hand) are distinguished by the arrangement of the three lugs 16 spaced in the working direction R. For this reference is made to a comparative view of these figures. It is recognizable that in the embodiment according to FIG. 3 (or 4A, 4B) the two outer lugs 16 are upstream of the central, inner lug 16 in the working direction R and the inner lug 16 is downstream of the outer lugs 16 in the working direction and consequently behind the outer lugs by a predetermined dimension. This is also recognizable in a comparative view of FIG. 4A and 4B, where in FIG. 4A one of the outer lugs and in FIG. 4B the central lug that is downstream are recognizable.

In contrast, in the embodiment (also according to variant A) according to FIG. 5 (or 6A, 6B) the outer lugs 16 are rearward of the inner lug 16, i.e. the middle lug is positioned in front of the outer lugs and consequently further forward. This results in turn from a comparative view of the FIGS. 6A and 6B, where FIG. 6A again shows one of the outer lugs and FIG. 6B the middle lug.

In addition, in the embodiments according to FIGS. 3 and 5 a special alignment of the outer lugs 16 is provided, because these outer lugs 16 or their inner guide surfaces are oriented at an angle, so that the outer lugs 16 and the inner lug 16 are separated by a spacing X that expands in the working direction R and serves to discharge the divided briquettes 7. In particular combining this inclined position on the one hand and the offset arrangement on the other hand between the lugs 16 creates a sufficient intermediate space for the perfect discharge of the individual briquettes 7 without jamming or blockages that lead to shutting down of the system. The lugs 16 themselves can be inclined or they can each have (inner) inclined guide surfaces 16a that can be formed, for example, on the lugs 16 themselves having a thickness tapering in the working or transport direction.

A distinction must be made between the embodiments of variant A shown in FIGS. 3 to 5 and the embodiments of variant B shown in FIGS. 7 to 10. These always relate to embodiments with an even number b of briquettes 7 within a row 5a of briquettes. In all cases, both the number n of beater teeth 13 and the number m of lugs 16 are less than the number b of briquettes within a row 5a of briquettes.

FIGS. 7 to 9 shows the embodiment of variant B where for four briquettes 7 in a row 5a only three beater teeth 13 are provided in each row 12 of beater teeth 13 and only two lugs 16 at or below the impact edge 14 are provided. Thus FIGS. 7, 8 and 9 show the system during impact of the teeth 13 on the briquette row 5a. It is recognizable that the two outer teeth 13 of the row 12 of teeth 13 each act on the two outer briquettes 7 while the central tooth 13 acts on both of the two middle briquettes 7, and indeed in the middle and thus also at the separation point and on the material web 8b between the two briquettes 7. For this purpose, the middle tooth 13 can optionally be provided with a bump or a centering cam 13c that hits the separation points, although no lug is provided underneath. This results in perfect separation, although for the three material webs 8b only two lugs 16 are provided. Also in this embodiment, the outer lugs 16 can be oriented at an angle or have inclined guide surfaces 16a in the manner described above.

Variant B can be used not only for briquette strands 5 with four briquettes 7 in each briquette row 5a, but also for briquette strands 5 with a higher number of columns, where, for example, six, or even eight briquettes 7 are in a briquette row 5a. Reference is made by way of example to FIGS. 10A and 10B that illustrate the construction according to the invention according to variant B in a highly simplified manner for such briquette rows 5a.

According to FIG. 10A a briquette row 5a with six briquettes 7 needs only four beater teeth 13 and only three lugs. According to FIG. 10B a briquette row 5a with eight briquettes 7 needs only five beater teeth 13 and four lugs 16. Each outer briquette and each inner briquette pair is assigned a respective beater tooth 13. Each outer web 8b and each further second inner web 8b has a respective lug 16. Hence in this variant B always n=b/2+1 and m=b/2, where b is an even number. Of special importance is that, in variant B, the outer briquettes 7 break off over the lug 16 and the remaining inner pairs are so strongly bent between two lugs 16 with a tooth 13 that they separate at the web 8b.

Moreover, the figures show that in all embodiments the beater teeth 13 and the lugs 16 are positioned such that at least an inner tooth between two outer teeth can pass between two adjacent lugs and consequently passes them during the operation. Thus e.g. the embodiment according to FIGS. 3 and 5 ensures that the spaces between two adjacent lugs 16 are traversed by respective inner beater teeth 13 between the two outer 13 teeth. The two inner briquettes 7 of a briquette row 8B fall consequently not only simply through the space between the central lug and each outer lug 16, but they are guided through between the lugs with the help of the inner beater teeth 13. This improves conveyance of the briquettes and applies to the embodiment of FIG. 7 and also to the embodiments according to FIG. 10A and 10B, for also there each pair of neighboring lugs of a tooth are passed by at least an inner tooth. Thus is seen e.g. in FIG. 10A, the two inner beater teeth 13 pass between two adjacent lugs 16 and thereby convey away both briquettes 7 associated with the respective teeth and spaces.

The case of a briquette strand with briquette rows each holding three briquettes next to each other would be an alternative to the embodiments according to the invention in principle as would an embodiment with only two beater teeth and two lugs, where the two beater teeth would impact two outer briquettes and two lugs the two material webs. In one such embodiment, the middle briquette would fall between the two adjacent lugs, without a tooth passing the two adjacent lugs and taking the middle briquette with it. Compared to an embodiment with only two beater teeth, the embodiments according to the invention particularly with two adjacent lugs passed through by one beater, improved removal of the briquettes is ensured.

It exists in the otherwise the possibility of combining the variants A and B with each other, so that a mixed form of the variants A and B is realized. This can be done here by using the width of a briquette strand in a section the geometry according to variant A and in another section the geometry according to variant B. Such embodiments are also within the scope if this invention.

The beater drum 11 is formed in a manner known in principle as a rotor or beater rotor, and namely with the described rows 12 each with three or four beater teeth 13. Each individual tooth 13 consists of a holder 13a formed on the wheel 12 of the toothed drum 11 and a retaining plate 13b connected to the retaining projection 13a, the retaining plates 13b being detachably attached to the retaining projections 13a, e.g. by screws, so that the retaining plates 13b can be replaced as wear parts. This technology is known from the prior art. Within the scope of the invention, the lugs 16 can also be replaceable wear parts.

It is within the scope within the scope of the invention, that the rows 12 of teeth 13 and consequently also whose retaining plates 13b can have a different width. Thus there is the possibility that with only three teeth 13 the middle tooth 13 has a larger width or a smaller width than the two outer teeth 13.

1. An apparatus for cutting a briquette strand that has a succession of longitudinally spaced and transversely extending rows that each have at least three briquettes connected via transverse material webs, the apparatus comprising:
a movable beater assembly having a plurality of rows each of at least three beater teeth next to one another, and
a feeder supplying the briquette strand to the beater assembly in a longitudinal transport direction such that each row of beater teeth of the beater assembly strikes off the briquette strand supplied by the feeder on the one hand a single one of the transverse briquette rows and on the other hand subdivides the struck-off briquette row into individual briquettes.

2. The apparatus according to claim 1, wherein the feeder has an output end provided with a striking edge for striking off the transverse briquette rows and at or below the striking edge has lugs for the subdividing of the struck-off briquette rows into individual briquettes, the feeder having at least two spaced lugs next to one another.

3. The apparatus according to claim 1, wherein the beater assembly is a rotationally driven beater drum or has such a beater drum whose outer surface carries a plurality of the transverse rows each with at least three beater teeth next to one another.

4. The apparatus according to claim 2, wherein a number of the beater teeth in each of the rows of teeth of the beater assembly is one greater than a number of the lugs on the feeder.

5. The apparatus according to claim 2, wherein
the number of beater teeth in each row of teeth of the beater assembly is equal to the number of briquettes in each of the briquette rows; and/or
the number of the lugs of the feeder is smaller by one than the number of the briquettes in the transverse briquette rows.

6. The apparatus according to claim 5, wherein for each of the material webs between adjacent briquettes of a briquette row there is a respective lug.

7. The apparatus according to claim 2, wherein, with an even number of briquettes in the briquette rows and the number of teeth, n=b/2+1 applies and/or for the number of lugs, m=b/2 applies.

8. The apparatus according to claim 7, wherein the two outer briquettes of a briquette row each are struck by a respective tooth and between the outer pairs of briquettes briquette pairs there is a common tooth.

9. The apparatus according to claim 7, wherein there is a lug for each of the material webs of a briquette row and for each of the inner webs between the outer material webs inner webs of a briquette row there is a respective lug.

10. The apparatus according to claim 1, wherein at least an inner tooth between two outer teeth can pass between two adjacent lugs.

11. The apparatus according to claim 1, wherein of the plurality of lugs of the feeder next to one another the outer lugs are formed in such a way and/or are oriented in such a way that a space is formed between each outer lug and a respective adjacent inner lug that flares in a working direction and through which the subdivided briquettes are discharged.

12. The apparatus according to claim 11, wherein the outer lugs are each oriented at an angle and/or have a thickness tapering in the working direction.

13. The apparatus according to one of claims 2, wherein at least one of the lugs is offset relative to one or several other lugs in the working direction.

14. The apparatus according to claim 13, wherein an inner central lug is downstream or upstream of the outer lugs preceding or following next in the working direction.

15. The apparatus according to claim 2, wherein for subdividing a briquette strand with briquette rows that each have three briquettes next to one another, the beater has three beater teeth and the feeder has two lugs, each tooth being aligned with a respective briquette of a briquette row and each lug being aligned with a respective material web between two adjacent briquettes.

16. The apparatus according to claim 2, wherein for subdividing a briquette strand with briquette rows that each have four briquettes next to one another, the beater assembly has four beater teeth and the feeder has three lugs, each tooth being associated with a respective briquette of a briquette row and each lug being aligned with a respective material web between two adjacent briquettes.

17. The apparatus according to claim 2, wherein for subdividing a briquette strand with briquette rows that each have four briquettes next to each other, the beater assembly has three beater teeth and the feeder has two lugs, the two outer beater teeth striking against the two outer briquettes and the middle tooth striking against the two inner briquettes of the briquette row.

18. A system for making briquettes, the system comprising:
at least one briquetting press with which a briquette strand according to claim 1 can be produced continuously and
at least one apparatus according to claim 1 downstream of the briquetting press for cutting the briquettes strand emerging from the briquetting press.
